(19) United States
(12) Patent Application Publication
(10) Pub. No.: US 2013/0288292 A1
(43) Pub. Date: Oct. 31, 2013

(54) SURFACE-TENSION BASED FLOW GUIDANCE IN A MICROSTRUCTURE ENVIRONMENT

(71) Applicants: Ivar Meyvantsson, Madison, WI (US); Steven Hayes, Madison, WI (US)

(72) Inventors: Ivar Meyvantsson, Madison, WI (US); Steven Hayes, Madison, WI (US)

(21) Appl. No.: 13/978,938

(22) PCT Filed: Jan. 10, 2012
(86) PCT No.: PCT/US12/20808

§ 371 Date: Jul. 10, 2013

Related U.S. Application Data
(60) Provisional application No. 61/431,770, filed on Jan. 11, 2011.

(51) Int. Cl. B01L 3/00

(52) U.S. Cl. CPC B01L 3/50273
USPC 435/30; 435/309.1

(57) ABSTRACT

This invention relates to a device and method for engineering microchannel geometries to take advantage of surface tension to guide fluid location. This technology may be used to construct compartmentalized systems of various materials that are added in liquid state, and may be used in a liquid state, or may be solidified, gelled, cross-linked, polymerized, or alternatively may be accumulated through gravity (e.g. cell settling), or centrifugation.

### CROSS REFERENCE TO RELATED APPLICATION

The present application claims priority from U.S. Provisional Patent Application Ser. No. 61/431,770 filed Jan. 11, 2011, the disclosure of which is incorporated herein by reference in its entirety.

### FIELD OF THE INVENTION

The present invention relates to methods and apparatus for controlling the arrangement of liquids in a fluidic network. More specifically, the present invention relates to microfluidic methods and devices in which fluid compartment configurations are designed to control delivery of liquids and particles to specific regions while maintaining fluid and/or diffusive communication between regions, leading to repeatable multi-constituent constructs for testing or synthetic purposes.

### BACKGROUND OF THE INVENTION

Small volumes of fluid can be manipulated in microfluidic environments and this control can be accomplished by many techniques, including electro-osmotic flow, electrowetting, electrochemistry, and thermocapillary pumping. Surface properties have significant effects on liquid behavior, particularly when small volumes are involved. These surface effects can be described as capillary force, and form the basis of wick filling. In the past, patterning of hydrophilic and hydrophobic coatings has been exploited to accomplish desirable liquid motions (e.g., U.S. Pat. No. 6,821,485). Virtual walls have been created by patterning self-assembled monolayers to define hydrophilic and hydrophobic regions to guide fluid flow (Zhao et al., 2001); however, this approach is intractable for manufacturing.

Previously, specific methods have been demonstrated to create defined multi-constituent constructs with three-dimensional components. Photo-crosslinked hydrogels (Liu-Tsang et al., 2007) enable the construction of specific compartments that can have any geometry in the plane, but uniform vertically. This combination of geometric and chemical pattern requires specific chemistry for photo-cross-linking, and is not compatible with sensitive biological systems, such as cultured cells, on which it tends to have significant toxic effect.

Controlling the arrangement of constituents in microfluidic networks has important applications in a number of technologies. For example in the field of cell biology, it has been shown that the three-dimensional arrangement of cells and extra-cellular matrix proteins is essential to explain certain developmental and disease processes (Bissell and Radisky, 2001). These processes cannot be replicated in traditional cell culture on flat plastic. The processes can in some cases be replicated in three dimensional cell culture (Bissell and Radisky, 2001), and may be improved via specific geometric arrangements of cells (Khetani et al., 2008). For drug discovery, patterning of cells adjacent to three-dimensional extracellular matrix gels has been shown to facilitate quantification of migratory function (Echeverria et al., 2010). In the field of materials science, interfacial synthesis has, for example, been shown to enable creation of contiguous polymer membranes that span the entire interface—a structure otherwise intractable to manufacture.

It is frequently the case that biological models require the inclusion of multiple components: cells, extra-cellular matrix protein coatings or 3-D gels, dissolved protein, dissolved small molecules, and readout reagents. The ability to arrange these components in specific and repeatable three-dimensional geometries can have advantages in terms of biological relevance (e.g. tumor-stroma interactions), assay, sensitivity (e.g. invasion zero background), and new testing capabilities. Perhaps the most elegant mechanism to form this liquid compartmentalization in microfluidic structures is to affect flow based upon geometry alone, and utilize surface tension effects.

### SUMMARY

Delivery of liquids is carried out in a way utilizing surface tension effects to guide liquid samples to specific compartments. No walls are required to restrict the fluids to their respective compartments, but rather the liquid stream can be completely guided by compartment geometries which are varied in such a way that the tendency of systems to minimize energy drives preferential filling of desired compartments.

By manipulating the geometry of microfluidic structure such that two adjacent regions R1 and R2 arc connected, but where R1 has a greater tendency than R2 to wick in liquid based on capillary action, one can target the liquid specifically to R1, with minimal amounts of liquid entering R2. Given that the contact angle of the liquid on the surfaces of the structure is smaller than pi/2, this can be achieved via spontaneous filling solely on the basis of geometry, without manipulating the surface tension differentially in regions R1 and R2. Specifically, if the border between regions R1 and R2 is constructed such that for a small additional volume of liquid the increase in total energy of the liquid-solid-gas interface system when the liquid flows further into R1 is lower than the increase in total energy of that system if the liquid were to flow across the border into R2.

This controlled construction of micro-scale constructs may be utilized for drug candidate analysis on a wide variety of cell culture systems, in addition to applications in chemical analysis, chromatography, flow sensors, and microprocessor chip and fuel cell manipulation and fabrication.

According to one aspect, the present invention provides a device for guiding the flow and delivery of liquids and particles which contains a contiguous network of hollow microstructures in three dimensions, wherein the network has two or more three-dimensional regions that have two or more types of geometries that differentially affect capillary action.

In a related aspect, the contiguous network of hollow microstructures consists of two adjacent channels x and y, with equal lengths and widths, but wherein the height of channel x is less than half that of channel y, and the capillary force acting upon any liquid in the channels is greater in channel x than in channel y.

In another related aspect of the device, the surface separating channels x and y is vertical relative to an observer.

In yet another related aspect of the device, the contiguous network of hollow microstructures consists of three adjacent channels x, y and z with equal lengths and widths, and wherein the height of channels x and z is equal, but wherein the height of channel y is less than half that of channels x and z, and the capillary force acting upon any liquid in the channels is greater in channel y than in channels x and z.

In another related aspect of the device, the surfaces separating channels x, y and z are vertical relative to an observer.

In yet another related aspect of the device, the surfaces separating channels x, y and z are horizontal relative to an observer.

In another related aspect of the device, the contiguous network of hollow microstructures is comprised of a main channel having a bottom and two sidewalls, and a common continuous covering living a surface facing the base surface, where the covering surface is not involved in defining the flow path from a source position to a destination position on the base surface.

In another related aspect of the device, the contiguous network of hollow microstructures is comprised of a main channel having a bottom and two sidewalls, but lacks a ceiling surface making the network of microstructures open to an air interface above.

In another aspect, the present invention provides a method of using a device within a contiguous network of hollow microstructures in three dimensions where the method comprises, adding liquids to the device such that the liquids preferentially fill one region over other regions on the basis of preferential geometry which directly affects capillary action.

In a related aspect of the method, the difference in geometry between regions of the device consists of differences in channel heights.

In another related aspect of the method, the device is used to create compartmentalized systems of materials that are added in a liquid state.

In another related aspect of the method, the materials are added in a liquid state, then utilized either in a liquid state or solidified, gelled, cross-linked, polymerized, or alternatively accumulated through gravity (e.g. cell settling), or centrifugation.

Further features and advantages of this invention are elucidated in the detailed description when taken in conjunction with the accompanying drawings.

### BRIEF DESCRIPTION OF THE DRAWINGS

FIG. 1 is a simplified three dimensional perspective view of a first compartmentalized microstructure environment in accordance with the invention.

FIG. 2 is a top view of the base portion of the structure of FIG. 1 and three cross-sectional views of the structure of FIG. 1 showing flow patterning networks.

FIG. 3 is multiple views of the structure of FIG. 1 showing the formation of compartmentalized microstructure environments where liquids are deposited and flow streams are sequentially demonstrated.

FIG. 4 is a simplified three dimensional perspective view of a second compartmentalized microstructure environment in accordance with the invention.

FIG. 5 is a top view of the base portion of the structure of FIG. 4 and three cross-sectional views of the structure of FIG. 4 showing flow patterning networks.

FIG. 6 is multiple views of the structure of FIG. 4 showing the formation of compartmentalized microstructure environments where liquids are deposited and flow streams are sequentially demonstrated.

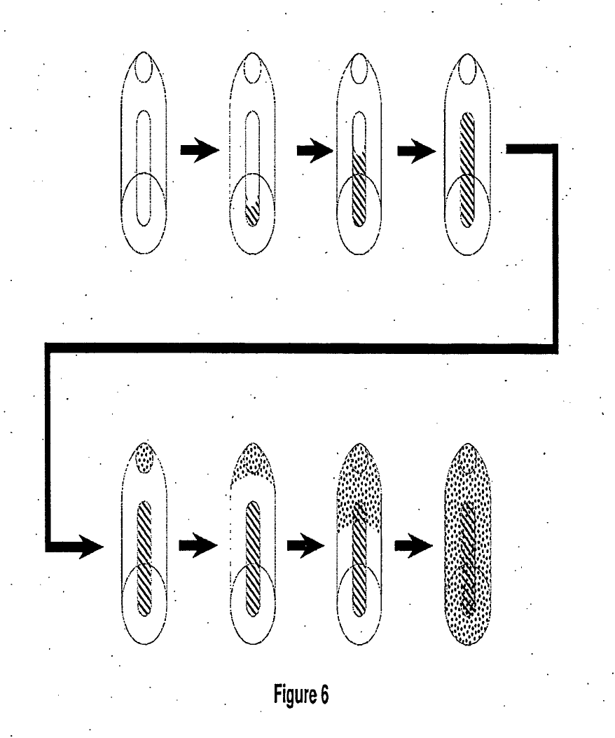

FIG. 7 is a schematic of cross-section of two simple geometries of FIG. 4 that have two regions with different capillary properties (a wider top layer and a narrower bottom layer), and a variety of ways gels, media, air and different populations of cells can be patterned based on capillary patterning. This figure demonstrates that the microstructures can be described with both an open or closed top.

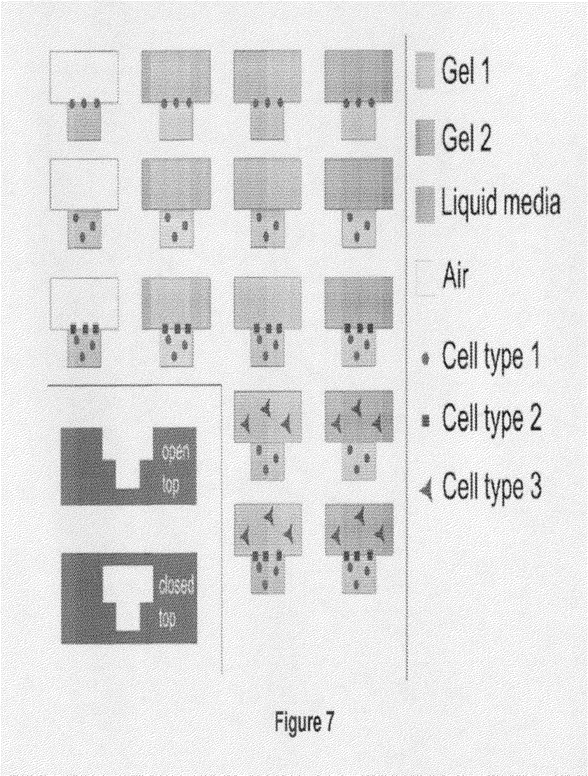

FIG. 8: Fluorescent beads can be patterned in gel and media in adjacent compartments. For this experiment a microfluidic structure was produced from cyclo-olefin polymer; the structure had a microfluidic network consisting of two regions in agreement with the present, invention; each region was connected to a separate port at one and, and both regions were joined at a common port at the other end; the center portion of each region were of equal length and width (see scalebar), but region 1 was 0.1 mm deep while region 2 was 0.7 mm deep; this conferred a stronger tendency for capillary action for region 1 compared to region 2. Using a handheld electronic pipette 1.25 μL matrigel (90%) with suspended red fluorescent beads were dispensed at port 1. The liquid wicked spontaneously into the structure and filled region 1 as shown in the panel labeled “Red”. A very small amount of the liquid was observed along the periphery of region 2 as evident by the thin line of fluorescent objects in the panel labeled “Red”. The liquid spontaneously turned into a gel after a few minute incubation at RT. Once that had happened, 12 μL of growth media (90%) with green fluorescent beads suspended was dispensed to port 2. The liquid wicked spontaneously into the channel and filled region 2. After a short incubation to allow the green beads to settle to the bottom, the device was imaged using an inverted epifluorescence microscope at 10× magnification and several images stitched together to created a view of the entire structure.

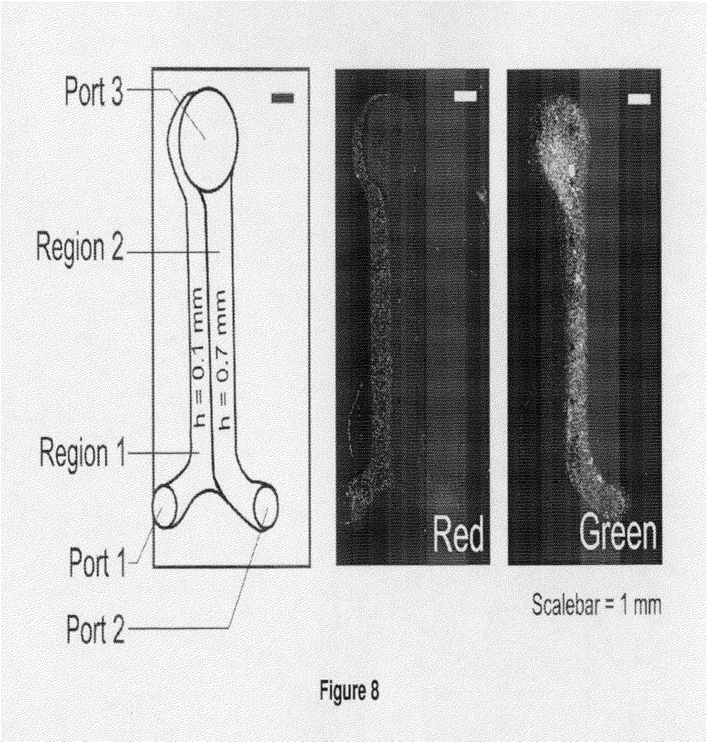

FIG. 9 shows Surface-tension based patterning can be used to establish an invasion assay. Using the same structure as in FIG. 8 and using the same protocol, we loaded matrigel in region 1, and M4A4 cells (which express green fluorescent protein) in region 2. In a controlled environment (37° C., 5% CO₂) on the stage of an epifluorescent microscope a time sequence of images was captured. Shown are images acquired at (left to right): t=0, t=24 h, t=48 h at the same location each time. The cells were observed to invade into the matrigel in a formation that is consistent with the scientific literature. It is evident from these figures that the structure formed by the patterning of the gel and cells is suitable for an invasion assay.

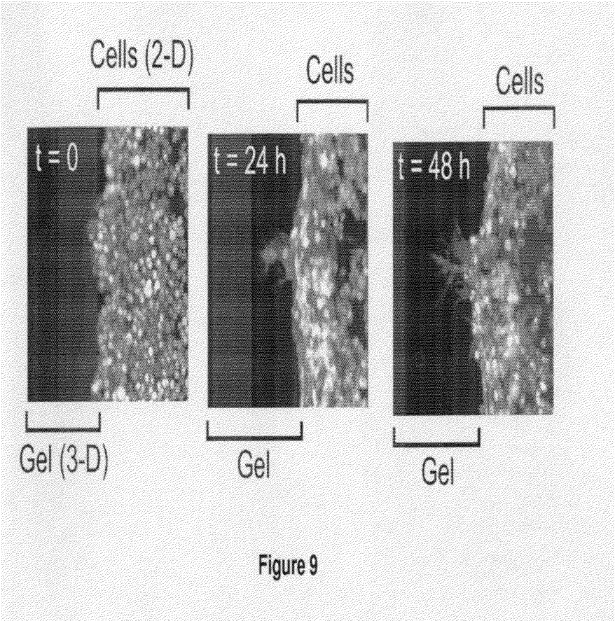

FIG. 10 shows possible additional geometries with a plurality of regions labeled 30-62.

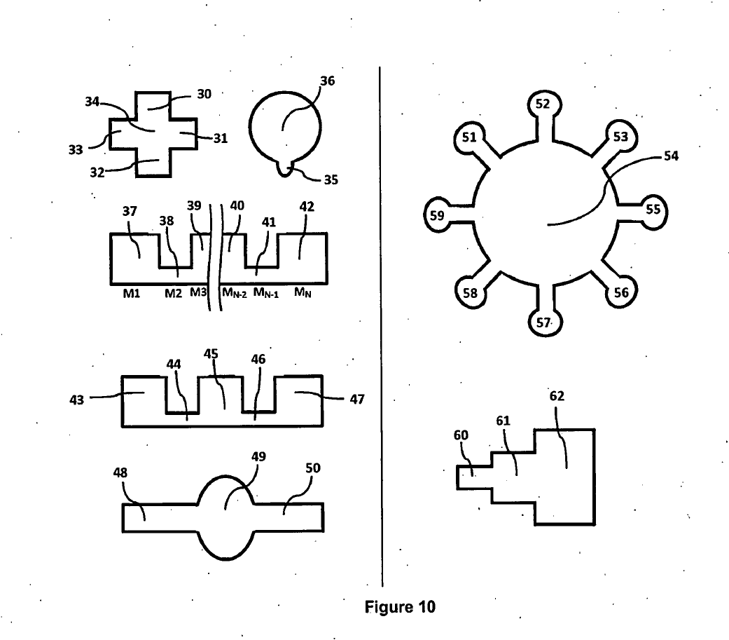

FIGS. 11 A-C show immunocytochemistry staining of PC3-M Cells embedded in 3D matrix. PC3-M cells were embedded in 3D Matrigel™ (90%) on the Iuvo™ Slide—3D ICC platform (Figure A.). Once the matrix gelled, growth media (with and without 20 μM Cycloheximide) was added to the side compartments of the channel. Following incubation, the cells in the matrix were fixed by flowing reagents through the side channels and allowing sufficient time for diffusion into the gel. A standard immunocytochemistry protocol (4% formaldehyde fixative, 0.5% TX-100 permeabilization buffer, 10% goat serum blocking buffer, primary antibody for Ki67 from LabVision, and AlexaFluor®594 secondary antibody) was utilized. Single-plane images capture full depth of ECM and show loss of proliferation marker (Figure B.), Ki67 in cells treated with Cycloheximide. FIG. 11 C. is a graph showing the quantitative analysis of the immunocytochemistry staining of PC3-M Cells embedded in a 3D Matrix.

### DETAILED DESCRIPTION OF PREFERRED EMBODIMENTS

### Definitions

Surface tension is used herein to describe an increase in the area of an interface requires energy. Interfacial tension, γᵢ, equals the energy required to increase the interfacial area by one unit:

δW=γᵢδA.

The interfacial tension of the interface between a liquid and air, or between a solid and air, is referred to as surface tension.

Capillary force is used herein to describe the force per unit length at an air-solid-liquid boundary that results from surface tension.

Photo-crosslinking is used herein to describe a light-activated chemical reaction whereby a liquid polymer solution is rendered solid.

Wick filling is used herein to mean surface tension-driven filling of a cavity with fluid.

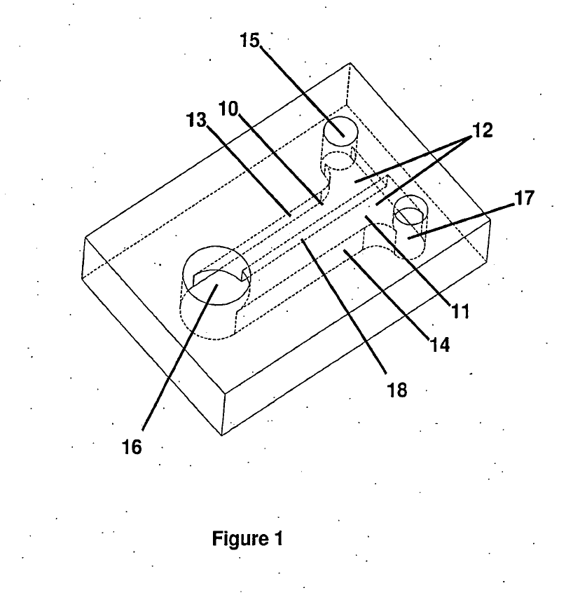

For the purposes of illustrating the principles of the invention, a representative three dimensional compartmentalized microstructure environment is shown generally in FIG. 1. This first compartmentalized microstructure environment includes two regions, R1 (10) and R2 (11). R1 and R2 are defined by a base 12, a ceiling and two sidewalls 13 and 14. R1 extends from port 1 (15) to a larger port 3 (16). R2 extends from port 2 (17) to a larger port 3 (16). Regions 1 & 2 are separated by a freeform boundary 18. It is understood that FIG. 1 is a structure shown for representational purposes only, and that microstructure environments may have a different number of channels and a wide variety of compartmentalized structures.

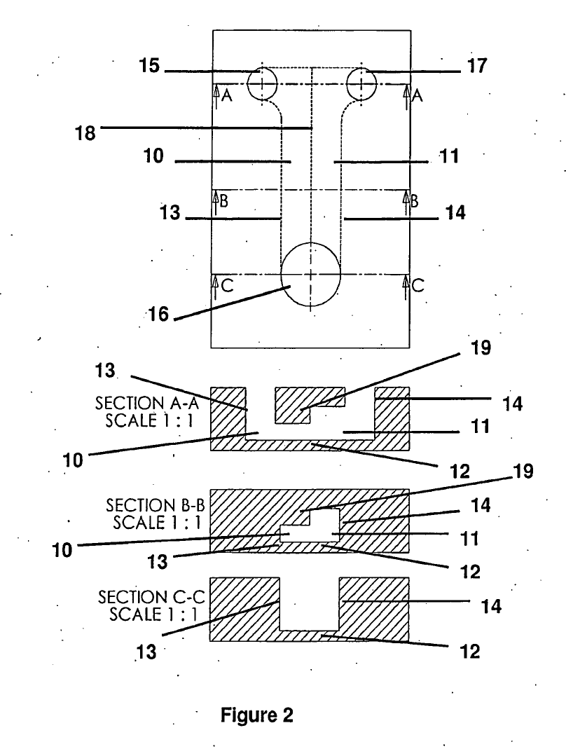

FIG. 2 is a top view of the base portion of the structure of FIG. 1 and three cross-sectional views of the structure of FIG. 1 showing flow patterning networks. These views of the first compartmentalized microstructure environment demonstrate two regions, R1 (10) and R2 (11). R1 and R2 are defined by a common base 12, a common ceiling 19 and two sidewalls 13 and 14. R1 extends from port 1 (15) to a larger port 3 (16). R2 extends from port 2 (17) to a larger port 3 (16). Regions 1 & 2 are separated by a freeform boundary 18. The cross-sectional diagrams (bottom panels) represent geometries at different segments of the overall microstructure at points A, B and C. It is understood that these cross-sectional geometries are representational only, and that the microstructure environments may have a wide variety of different geometries.

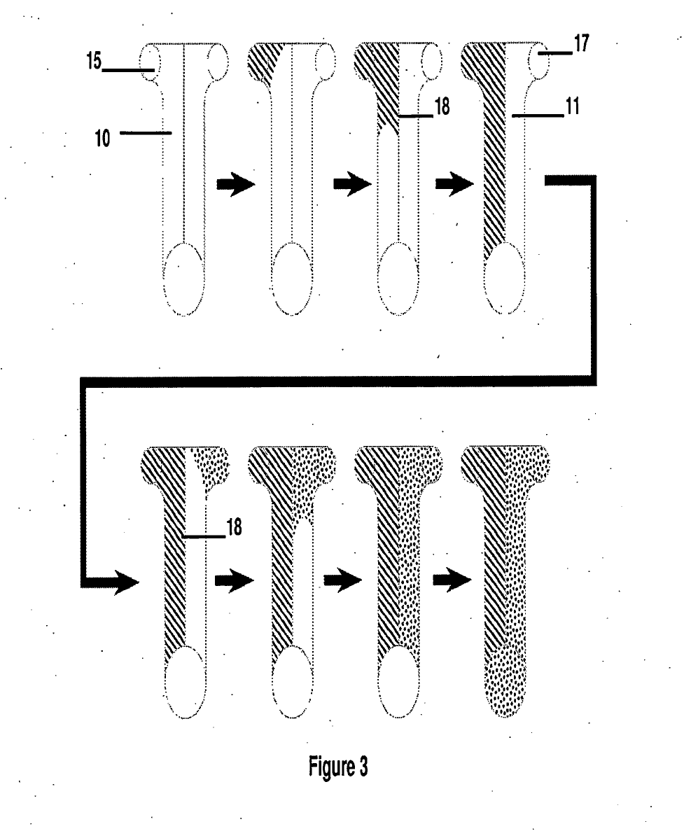

FIG. 3 is multiple views of the structure of FIG. 1 showing the formation of compartmentalized microstructure environments where liquids are deposited and flow streams are sequentially demonstrated. The first surface tension guided flow stream is shown in Region 1 (10) beginning at port 1 (15). Liquid flow in R1 is directed through preferential geometry from port 1 along the length of region (top panels). While the flow requires the material in R1 be in liquid form, one embodiment of the invention would allow for the material in R1 to then be solidified, gelled, cross-linked, or polymerized prior to the addition of material to R2 (11) through port 2 (17). Liquid flow in R2 is directed from port 1 by wick-filling along the freeform boundary (lower panels) between regions 1 and 2 (18). This directed flow within regions 1 and 2 results in defined compartments which may represent materials containing different chemistries, cellular components or cell types.

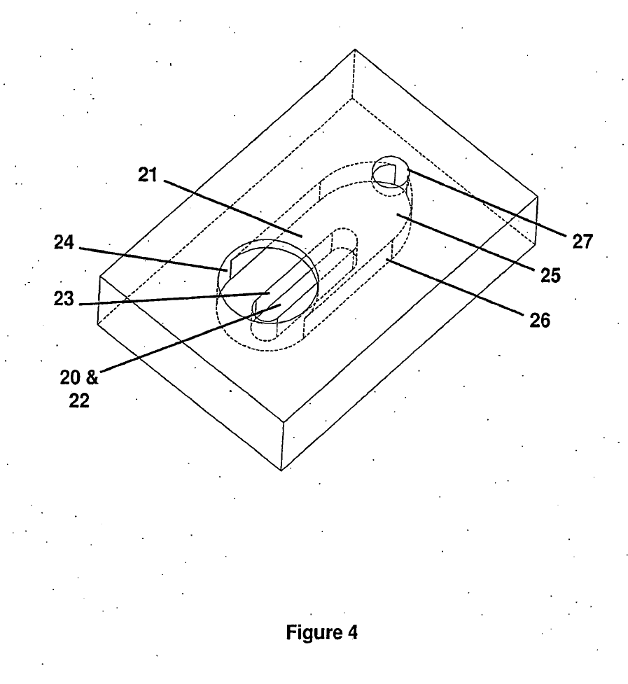

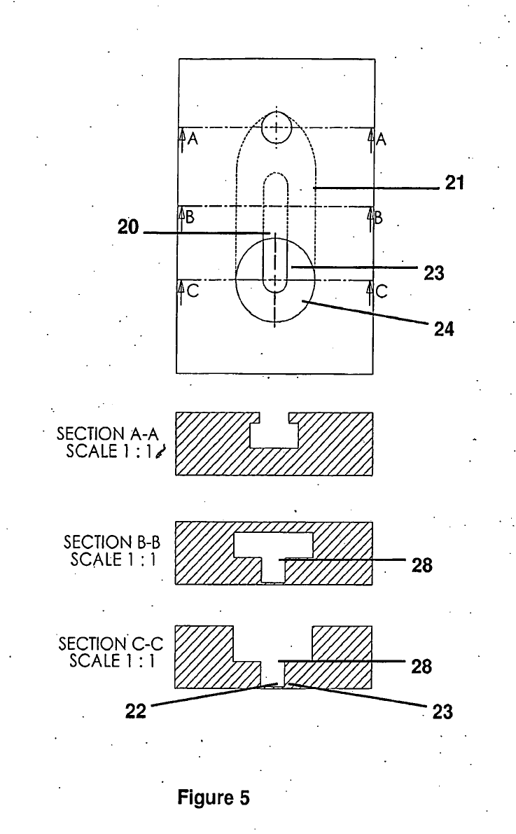

For the purposes of illustrating the principles of the invention, a second representative three dimensional compartmentalized microstructure environment is shown generally in FIG. 4. This second compartmentalized microstructure environment includes two regions, R1 (20) and R2 (21). R1 is defined by a base 22, and a surrounding sidewall 23. R1 is accessible from port 1 (24). R2 is defined by a base (25) and a surrounding sidewall (26). R2 (21) extends around Region 1 and is accessible from port 1 (24) but in a preferred embodiment would be accessed by port 2 (27). It is understood that FIG. 4 is a structure shown for representational purposes only, and that microstructure environments may have a different number of channels and a wide variety of compartmentalized structures. Regions 1 & 2 are separated by a horizontal freeform boundary 28 seen in cross-section in the two lower panels of FIG. 5.

By manipulating the geometry of microfluidic structure such that two adjacent regions R1 and R2 are connected, but where R1 has a greater tendency than R2 to wick in liquid based on capillary action, one can target the liquid specifically to R1, with minimal amounts of liquid entering R2. Given that the contact angle of the liquid on the surfaces of the structure is smaller than pi/2, this can be achieved via spontaneous filling solely on the basis of geometry, without manipulating the surface tension differentially in regions R1 and R2. Specifically, if the border between regions R1 and R2 is constructed such that for a small additional volume of liquid the increase in total energy of the liquid-solid-gas interface system when the liquid flows further into R1 is lower than the increase in total energy of that system if the liquid were to flow across the border into R2.

The interface between a liquid and air is deformable and thus the shape of the interface will change to minimize surface energy. While liquids flow readily, they will under influence of surface tension often form predictable shapes that are very stable (de Gennes et al., 2004). The same applies to the interface between two immiscible liquids.

To characterize the way a liquid spreads on a flat surface in an air environment, we define a spreading parameter:

S=γSO−(γSL+γ),

Where γSO is the surface tension of the solid (in air), γSL is the interfacial tension of the solid-liquid interface, and γ is the surface tension of the liquid (in air). When S>0, the liquid will completely wet the solid and form an extremely thin film. When S<0, the liquid will partially wet the solid; partial wetting means that the liquid forms a spherical cap on the surface, which will consistently have a contact angle θ_{E}. The contact angle can be determined on the basis of the surface tension forces acting at the line of contact between all three phases at the edge of the drop:

γ cos(θ_{E})=γSO−γSL.

When the contact angle is smaller than or equal to π/2, the liquid is referred to as “mostly wetting”, when it is larger than π/2 it is referred to as “mostly non-wetting”.

Non-zero interfacial tension causes a pressure difference across the interface, referred to as Laplace pressure. This pressure differential has been shown to equal:

$$δ p = γ ( \frac{1}{{R}_{1}} + \frac{1}{{R}_{2}} ) ,$$

where R₁ and R₂ are the two radii of curvature of the surface. At equilibrium the radii of curvature will be uniform across the entire surface.

When a liquid spreads on a solid surfaces that is not infinitely flat, but has a three-dimensional geometry, analytical solutions are generally intractable. However, solutions have been developed for several simple cases. One well known example is capillary rise; if glass capillaries of different diameter are dipped in water, the water will enter the capillaries and rise—against gravity—to different heights depending on the diameter; smaller diameter tubes will pull the liquid further than those of larger diameter. The height of the fluid has been shown to be described by the following equation:

$$H = \frac{2 γ cos {θ}_{E}}{ρ g R} ,$$

where H is the height of the liquid inside the capillary above its resting level outside the capillary, ρ is the density of the fluid, g is gravity, and R is the radius of the capillary. The intensity of the capillary rise phenomenon grows rapidly with decreasing R. An analogous effect is observed with more complex structures that are on the same length scale as capillaries, i.e. sub-millimeter.

When a liquid has two distinct capillary-like structures to choose from, it will preferentially fill the structure that has a smaller dominant geometry. The dominant geometry is usually the smallest dimension of the structure. For example only, consider a capillary tube where a notch with a half circle cross-section of significantly smaller radius than the capillary has been added to the inside surface of the capillary. This structure would be expected to preferentially wick liquid along the notch over the main lumen of the capillary.

For example only, if a microfluidic network were constructed with two inputs, one input connected to a shallow channel and the other input connected to a deep channel, and liquid were being added to the shallow channel via the input, the liquid would be expected to fill the entire shallow region before overflowing into the deeper region. The channels may have a rectangular or curvilinear surface.

### Example 1

The device and method described here may be utilized to construct an experimental model of tumor cell invasion. In vivo, the tumor cells are initially contained within a tumor mass, but as the tumors turn malignant, the cells develop the ability to break free of the tumor mass and invade into the surrounding connective tissue. One embodiment of this application would be a microfluidic structure where the first region would be prepared to contain a gel representing the connective tissue, and the second region would be prepared to contain cells representing the tumor. Since the gel can be made such that it initially has no cells, migration, or invasion, of cells into the gel is easily detected and quantified. The process can be quantified in terms of cell number reaching beyond a certain distance inside the region, or by a statistical analysis of cell location across the population. If the gel is collagen-I, the assay will enable an analysis of tumor cell migration through connective tissue. If the gel is matrigel, the assay will enable analysis of tumor cell ability to break out of an epithelial layer, though a layer known as basement membrane, into connective tissue. If the gel is collagen-I, but coated with matrigel prior to introduction of cells, the assay will even more closely model the arrangement of cells and proteins that occurs in vivo and enable simultaneous testing of ability to break through basement membrane and migrate through connective tissue.

### Example 2

Another embodiment of this application involves the construction of a biological model assay where cells are sandwiched in between two layers of an extracellular matrix gel. The purpose of doing this is to provide the cells with a three-dimensional environment in which to grow. This type of arrangement has been shown to provide significant advantages over culturing the same cells on extracellular matrix-coated, rigid plastic surfaces (Montesani et al. 1983); this is applicable to multiple types of cells, including endothelial cells and hepatocytes. The basis for these advantages is believed to be due better resemblance to human tissues both in terms of biochemical and mechanical cues experienced by the cells. With respect to the technology presented in this provisional patent application, one region could be filled with the extra-cellular matrix (ECM) of interest, and allowed to gel. A second adjacent region could be filled with a cell suspension in cell culture media. With the device oriented appropriately relative to gravity, the cells would be made to settle on the surface of the ECM. Once the cells would have adhered to the ECM gel, the second region would also be filled with ECM. Since the flow profile in microfluidic channels is parabolic, the volume of ECM added may need to be several times that of the channel in order to ensure the second ECM gel comes into contact with the cell layer.

### Example 3

The device and method presented here could be used to construct a co-culture or multiple cell types. It has become clear the many developmental and disease processes, including cancer progression, depend on inter-cellular communication. While cells can be mixed together there is often an advantage to segregating them into different regions; segregation eliminates need for artificial tags to label different cell types; while soluble signals may be required a random mixture may interfere with formation of important morphologies; often, as in the case of epithelium and stroma, the cell populations are segregated in vivo. The current invention could serve to provide two or more adjacent compartments where different cell types are seeded in three-dimensional gels or on two-dimensional surfaces.

### Example 4

Yet another embodiment of the current invention would entail the formation of a cell culture at an air-liquid interface. Several tissues are best modeled in this manner, most notably airway epithelium. The current invention could serve to construct a three-dimensional gel with or without supporting stromal cells, and with or without a matrigel coating to represent a basement membrane. On top there would be a layer of airway epithelial cells, which would be kept moist via media that hydrates the underlying gel. Instead of media or another gel, the adjacent region would remain filled with air. Similar models have been constructed on membranes in modified boyden chambers. A system based on the current invention would have the notable improvement of eliminating the membrane from the system, which would improve optics and eliminate a non-biological component from the structure.

### Example 5

Another embodiment of the invention would seek to model leukocyte responses to stimuli. Leukocytes circulating in the bloodstream are able to respond to signals from tissues by rolling on the endothelial surface, attaching and then exiting the vasculature via extravasation. The current invention offers the possibility of building a gel layer in one region representing stroma, and having a layer of endothelial cells cultured on top. Then media with leukocytes could be flowed through a second region along the interface on which the endothelial cells are cultured. Given appropriate stimuli endothelial cells have been shown to enable rolling and attachment in vitro. The present invention would be capable of providing the additional benefit of testing extravasation into a gel compartment.

### Example 6

Yet another embodiment of the invention would involve a model of the blood-brain barrier. This is a particularly impermeable layer of endothelial cells and protein that is very important in pharmaceutical research and toxicology. The invention would provide the ability to arrange the appropriate cells and biomolecules to model the structure.

### Example 7

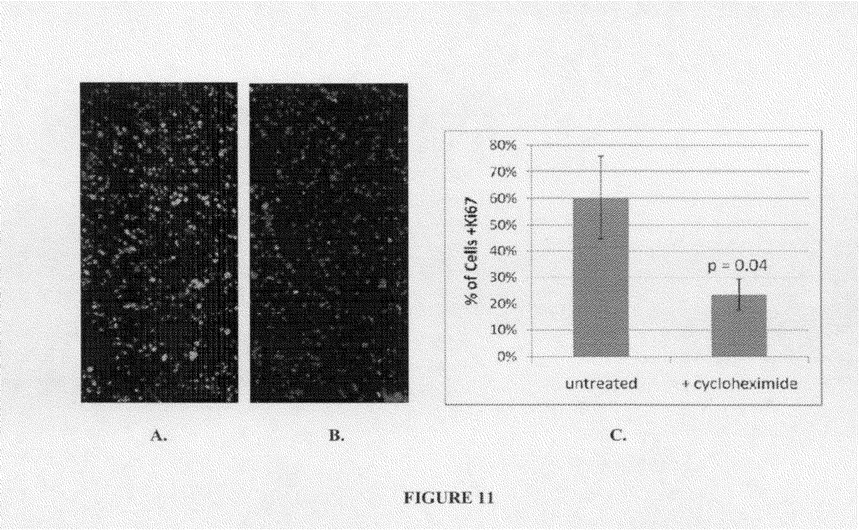

Another embodiment of the invention provides a device that enables the use of assay methods requiring multiple liquid replacement, or wash steps that require the diffusion of large biomolecules, in matrices that are very dense, such as Matrigel™. For example, it is becoming increasingly clear that the lack of a native three dimensional tissue microenvironment seriously limits the utility and accuracy of cellular assays, many of which rely on immunocytochemistry as an endpoint. However, efforts to adapt three dimensional culture methods to multiwell plates have not been very successful, especially with dense matrices, because antibodies do not diffuse rapidly or efficiently enough in wells, and wash steps are very inefficient. One embodiment of this application would be a microfluidic structure where the first region, of lesser height, would be prepared to contain cells suspended in a dense matrix, and the second region, of greater height, would be used for additions of immunocytochemistry reagents including antibodies and wash buffers. In such a device, it is possible to obtain very efficient and rapid diffusion of large antibodies through a dense matrix, allowing the use of standard immunocytochemistry protocols, as shown in FIG. 11.

### Other Examples

The invention has multiple additional applications, including, but limited to 1) reducing the diffusion distance into dense matrices compared to other cell culture systems, 2) providing a compartment adjacent to a cell culture compartment dedicated to measurement of secreted factors; this would allow separation of readout reagents, and photo-induced stress from the cell culture compartment, 3) synthesizing of materials such as polymer layers at the interface of two liquid compartments via a chemical reaction, and 4) quantifying binding affinity by analyzing the diffusion of a fluorescent binding partner away from an interface. This could for example be a competitive binding assay, where the diffusivity of a probe increases significantly when the analyte binds to a large entity (e.g. antibody) and releases the probe into solution.

It is understood that the invention is not confined to the particular embodiments disclosed herein as illustrative, but embraces all such forms thereof as come within the scope of the following claims.

While specific embodiments of the subject matter have been discussed, the above specification is illustrative and not restrictive. Many variations will become apparent to those skilled in the art upon review of this specification and the claims below. The full scope of the invention should be determined by reference to the claims, along with their full scope of equivalents, and the specification, along with such variations.

Also, recitation of ranges of values herein are merely intended to serve as a shorthand method of referring individually to each separate value falling within the range and each endpoint, unless otherwise indicated herein, and each separate value and endpoint is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All publications and patents mentioned herein are hereby incorporated by reference in their entirety as if each individual publication or patent was specifically and individually indicated to be incorporated by reference.

While specific embodiments of the subject matter have been discussed, the above specification is illustrative and not restrictive. Many variations will become apparent to those skilled in the art upon review of this specification and the claims below. The full scope of the invention should be determined by reference to the claims, along with their full scope of equivalents, and the specification, along with such variations.

### RELATED PUBLICATIONS

1. Zhao B, Moore J S, and Beebe D J. “Surface-Directed Liquid Flow Inside Microchannels”, Science, Vol. 291 no. 5506 pp. 1023-1026, 2001.
2. Liu Tsang, V, Chen, A A, Cho, L M; Jadin, K D, Sah, R L, DeLong, S, West, J L, and Bhatia, S N (2007) Fabrication of 3D hepatic tissues by additive photopatterning of cellular hydrogels. FASEB Journal, 21: 790-801.
3. Bissell M J and Radisky D, “Putting tumours in context”, Nature Reviews Cancer 1, 46-54 (October 2001).
4. Khetani S R, and Bhatia S N, “Microscale culture of human liver cells for drug development”, Nature Biotechnology 26, 120-126 (2008).
5. Echeverria V, Meyvantsson I, Skoien A, Worzella T, Lamers C, and Hayes S, “An Automated High-Content Assay for Tumor Cell Migration through 3-Dimensional Matrices”, Journal of Biomolecular Screening, 15(9):1144-1151, 2010.
6. De Gennes P-G, Brochard-Wyart F, Quere D, “Capillarity and Wetting Phenomena”, Springer, 2004.
7. Montesano R, Orci L, and Vassalli P, “In vitro rapid organization of endothelial cells into capillary-like networks is promoted by collagen matrices”, The Journal of Cell Biology, 97(5):1648-1652,1983.

What is claimed is:

1. A device for guiding the flow and delivery of liquids and particles which contains a contiguous network of hollow microstructures in three dimensions, wherein the network has two or more three-dimensional regions that have two or more types of geometries that differentially affect capillary action.

2. The device of claim 1 wherein the contiguous network of hollow microstructures consists of two adjacent channels x and y, with equal lengths and widths, but wherein the height of channel x is less than half that of channel y, and the capillary force acting upon any liquid in the channels is greater in channel x than in channel y.

3. The device of claim 2 wherein the surface separating channels x and y is vertical relative to an observer.

4. The device of claim 2 wherein the surface separating channels x and y is horizontal relative to an observer.

5. The device of claim 1 wherein the contiguous network of hollow microstructures consists of three adjacent channels x, y and z with equal lengths and widths, and wherein the height of channels x and z is equal, but wherein the height of channel y is less than half that of channels x and z, and the capillary force acting upon any liquid in the channels is greater in channel y than in channels x and z.

6. The device of claim 5 wherein the surfaces separating channels x, y and z are vertical relative to an observer.

7. The device of claim 5 wherein the surfaces separating channels x, y and z are horizontal relative to an observer.

8. The device of claim 1 wherein the contiguous network of hollow microstructures is comprised of a main channel having a bottom and two sidewalls, and a common continuous covering having a surface facing the base surface, wherein the covering surface is not involved in defining the flow path from a source position to a destination position on the base surface.

9. The device of claim 1 wherein the contiguous network of hollow microstructures is comprised of a main channel having a bottom and two sidewalls, but lacks a ceiling surface making the network of microstructures open to an air interface above.

10. A method of using a device within a contiguous network of hollow microstructures in three dimensions wherein the method comprises, adding liquids to the device such that the liquids preferentially fill one region over other regions on the basis of preferential geometry which directly affects capillary action.

11. The method of claim 10 wherein the difference in geometry between regions of the device consists of differences in channel heights.

12. The method of claim 10 wherein the device is used to create compartmentalized systems of materials that are added in a liquid state.

13. The method of claim 12 wherein materials are added in a liquid state, then utilized either in a liquid state or solidified, gelled, cross-linked, polymerized, or alternatively accumulated through gravity (e.g. cell settling), or centrifugation.
